(19) United States
(12) Patent Application Publication
(10) Pub. No.: US 2004/0100251 A1
(43) Pub. Date: May 27, 2004

(54) Active magnetic field sensor, use thereof, method and device

(76) Inventor: Peter Lohberg, Friedrichsdorf (DE)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 10/343,504

(22) PCT Filed: Aug. 1, 2001
(86) PCT No.: PCT/EP01/08920

(30) Foreign Application Priority Data
Aug. 2, 2000 (DE) 100380336
Oct. 20, 2000 (DE) 100524079
Nov. 9, 2000 (DE) 100555322

(51) Int. Cl. G01P 3/48

(52) U.S. Cl. 324/166; 324/173; 361/236; 340/426.1

(57) ABSTRACT

The present invention relates to an active magnetic field sensor, in particular a wheel bearing sensor unit, comprising at least one magnetic sensor element (10, 21, 36) for converting a temporally periodic magnetic field into a temporally periodic electric sensor signal at signal outputs (37, 31) and an electronic signal-evaluating circuit, the said magnetic field sensor being electrically fed by way of a sensor interface, wherein an active electric processing of periodic signals (38, 39) of the magnetic sensor element is performed in two or more separate signal channels of the evaluating circuit respectively associated with the sensor signals.

The present invention further discloses a motor vehicle influencing device and a method preventing a vehicle from rolling on an inclined plane.

The present invention relates to an active magnetic field sensor according to the preamble of claim 1, use thereof according to claim 25, a wheel bearing sensor unit according to the preamble of claim 22, a motor vehicle influencing device according to the preamble of claim 23, as well as a method according to the preamble of claim 26.

EP 0 736 183 A1 discloses the use of active magnetic field sensors for measuring the rotational speed of the wheels of a motor vehicle. These sensors are required to determine, among others, the vehicle speed for electronic anti-lock systems (ABS) and also for systems for controlling driving dynamics (ESP, TCS) and therefore have a wide spread usage.

The active sensors detect the magnetic field of so-called magnetic encoders co-rotating with the wheel, said encoders being frequently designed as a permanent-magnetic ring having an alternating sequence of north/south pole magnetizations. It is also commonly known that the active sensors relay the rotational speed information to an electronic brake control unit (ECU) by way of a current interface.

Encoders made up of magnetized bodies are used nowadays for anti-lock brakes and driving dynamics control systems in a large number of motor vehicles, said encoders being mechanically connected to the rotating ring of a wheel bearing. For example, the wheel bearing seal itself may exhibit the encoder magnetization. It is also usual to employ as generator wheels for the active sensors ferromagnetic encoders such as toothed gears or toothed discs of steel, e.g. magnetized wheel bearing seals.

Active sensors detecting the direction of rotation in addition to the wheel rotational speed are also known in the art. In German patent application DE 19634715.7 a corresponding arrangement for detecting the rotational behavior of a rotating encoder is described. The active sensor comprises a magneto-resistive resistor element receiving a magnetic field signal and relaying it to a modulator that modulates the current signal in dependence on the wheel speed. The current signal relayed to the brake control unit is pulse-like coded, with pulses with two amplitudes being transmitted. The distance between the pulses with the higher amplitude is an indicator of the wheel speed. It is possible according to DE 19634715.7 to transmit individual status bits between these pulses in the more or less short pulse pause, with the condition of one of the transmitted bits also containing information about the direction of rotation of the wheel.

In German patent application DE 19911774.8 an interface for the above speed sensor is described, wherein the information about the direction of rotation and validity thereof is contained as a 2-bit information within an 8-bit word that is sent after each speed pulse.

Further, active sensor elements on the basis of the Hall effect can be obtained (TLE 4942, Infineon Technologies AG, Munich) which make available an output signal in the form of a current interface, the said output signal transmitting in a coded fashion the rotational speed and also information about the direction of rotation. The signal produced comprises simple square-wave current pulses of the same amplitude, and the additional information about the direction of rotation is coded by the pulse width.

Arrangements for speed detection in motor vehicles must operate with a high rate of precision, they must be reliable and permit low-cost manufacture. Further, the available mounting space is greatly limited in the majority of cases. Because wheel speed sensors are further exposed to rough environmental conditions for long periods of time, special constructive measures are necessary to satisfy the above-mentioned demands.

In prior art wheel speed sensors on the basis of magneto-resistive effects, such as AMR (Anisotrop Magneto Resistive) sensors or GMR (Giant Magneto Resistive) sensors for the application in controlled brake systems, which beside the wheel speed information also transmit information about the direction of rotation, the number of the generated signal periods at the output of the active sensor in a magnetized encoder is precisely in conformity with the number of north/south pole alternations which pass by the sensor element during a rotation of the encoder, or, respectively the number of tooth/gap alternations in a ferromagnetic transducer. This means that one pulse at the output of the sensor corresponds to each alternation in magnetization.

It is to be noted in this respect that it is currently a standard with anti-lock systems to subdivide the circumference of the encoder (reading track) into roughly 48 north/south pole pairs.

The present invention deals with the idea that it is appropriate to improve existing systems for controlling the driving condition of motor vehicles by increasing the resolution and information variety in the wheel speed detection arrangement. Thus, it is e.g. desirable to provide a more accurate anti-lock system that permits shortening the stopping distance due to a higher resolution.

Therefore, the present invention discloses an active magnetic field sensor for detecting the wheel speed according to claim 1.

The present invention discloses an active wheel speed sensor that permits achieving an angular resolution which, compared to prior art sensors, is increased in terms of the signal pulses produced per encoder pole alternation and, in addition, renders it possible to provide a direction-of-rotation signal that is time-synchronously transmitted with the rotational speed pulse.

The wheel speed sensor of the present invention preferably comprises a magnetic sensor element for converting a time-responsive periodic magnetic field into a time-responsive periodic electric sensor signal, wherein a periodic electric sensor signal is produced at each of the two signal outputs, and these signals in relation to each other have a phase shift of ±φ. Among others, the direction of rotation of an encoder can be recognized by means of the independent periodic signals.

The sensor of the invention can be manufactured with magnetic converters of a different mode of operation. Thus, e.g. magneto-resistive sensor elements or Hall sensor elements can be employed.

In a way preferred by the invention, structures with a per se known Barper pole structure for linearization of the characteristic curve are used as magneto-resistive sensor elements. However, it is also possible to use magneto-resistive elements without a Barper pole structure as sensor elements, for example, in an electric bridge circuit arranged on a plane, with the normal line of the sensor plane being aligned so that said plane is aligned vertically to the normal line on the encoder track and vertically to the moving direction of the encoder. This allows utilizing a vector component of the encoder that rotates by 360° in the sensor element during the encoder movement. Due to the air gap which always prevails in rotational speed sensors, usually, however, not all the fields made of a magnetic-field sensitive material that exist in the sensor element are fully saturated magnetically by way of the magnetic field, as is the case in per se known angular sensors, wherein a permanent magnet is rotating directly above the sensor plane.

Preferably, per se known differential Hall elements are used as transducer elements operating according to the Hall effect. Said Hall elements may in particular be configured so that they exhibit one joint center area and two outside areas being displaced in relation to one another by a defined amount.

To sense the rotatory quantity of motion, there is additional need for a pulse generator that is referred to as encoder in the sense of this invention. The encoder is a machine element in which an incremental angular measure, the so-called encoder track, is impressed in the shape of an even subdivision. In the example of the wheel speed detection, the encoder is coupled mechanically to the rotating wheel, and the encoder track is magnetically sampled in a non-contact manner by way of an air gap, by means of the sensor mounted on the vehicle.

The encoder which can be used in the arrangement of the invention either contains a permanent-magnetizable material or a ferromagnetic material in the area of its circumference.

In an encoder made of ferromagnetic material, appropriately, the encoder may in general consist completely of ferromagnetic material.

Especially preferred ferromagnetic encoders are e.g. toothed gears made of steel or toothed discs which are structured along the circumference, such as with a sequence of tooth/gap or hole/web, respectively.

In connection with ferromagnetic encoders, induction coils, magneto-resistive structures, and Hall elements may be used as sensor elements, with a permanent magnet generally fitted to the sensor element being required in this type of encoders due to the lacking permanent magnetization.

When the encoder is an encoder comprising permanent-magnetizable material, a multipolar magnetization is applied preferably in the zone of circumference, especially in the form of a sequence of alternating north and south pole magnetizations of the permanent magnetic material. The multipoles then form an incremental angular measure along the encoder circumference.

In the case of annular encoders, the areas form a circular so-called encoder track which can be applied either on the peripheral surface of a disc-shaped encoder or on the disc surface.

An ‘active sensor’ under the present invention refers to a probe which requires an external electric energy supply for its operation.

When Hall elements are employed as sensor elements, permanent-magnetic encoders or ferromagnetic encoders are favorably provided as encoders.

The sensor elements convert the periodic magnetic signal into a periodic electric signal whose period images one time or several times the incremental angular spacing of the encoder as a temporal voltage or current signal.

Advantageously, the magneto-resistive sensor elements are either AMR or GMR sensors. It is especially preferred to use magneto-resistive sensors according to the AMR principle.

The magnetic-field-sensitive structures are arranged on the sensor element favorably in a planar fashion, especially on one joint main plane of the sensor element. The structures produce an electric signal in connection with an evaluating circuit in dependence on the field strength and on the direction of the field.

The sensor circuits (transducers) arranged on the sensor element for measuring the magnetic field are preferably mounted in the form of bridge circuits (e.g. Wheatstone bridge), multiple bridges (bridge arrays) or partial bridges. A Wheatstone bridge comprises two partial bridges. Multiple bridges are bridge circuits with more than two partial bridges. Therefore, the term ‘partial bridge’ refers to parts of a sensor circuit together forming a full bridge (Wheatstone bridge). Favorably, the partial bridges of the invention are so arranged in relation to each other that the signals produced are shifted by the phase φ relative to each other in dependence on a magnetic field varying temporally according to the encoder's rotation.

Preferably, two partial converters independent of each other are used in the sensor elements, said converters being either shifted by a distance d or twisted about an angle φ relative to one another.

The said shift or the said twist, respectively, then causes the signal phase shift φ at the output of the sensor element which has been mentioned already hereinabove.

In the case of two partial transducers (full bridges or half bridges) two phase-shifted partial signals independent of each other such as A·Sin(ω·t) and B·Sin(ω·t±φ) can be obtained.

It is preferred to configure the twist or shift by adapting the transducer and the encoder so that partial signals are obtained which are generally orthogonal relative to each other. This may be done by designing the arrangement composed of encoder and sensor element so that an identity of A and B as well as an angle φ of 90° is striven for in the above formula.

Depending on the way the sensor element is oriented to the encoder, it may be expedient to use a biasing magnet for biasing the magneto-resistive element.

The magnetic sensor of the invention permits sampling an encoder with an increased displacement resolution or angular resolution. Depending on the case of application, it may be desirable either to use the achieved increase in resolution for providing e.g. a more accurate anti-lock system or to compensate the resolution of the sensor assembly by a more coarse division (increase of the module) of the encoder in such a manner that the resolution of the sensor output signal remains unchanged. The advantage of the last-mentioned application is that the air gap can be considerably increased by the internal resolution increase provided by the present invention.

Thus, a sensor assembly may e.g. be achieved which, with a module of roughly 2 mm, is still operating reliably until an air gap of 2 mm, the said module m representing the ratio of the reading track diameter to the number of the north/south-pole pairs arranged on the encoder circumference.

It may also be expedient to reduce the pole division jitter instead of the air gap. A pole division jitter (also pole division error) implies the individual discrepancy of the signal periods from the mean value of a signal period with respect to a rotation of the encoder. The pole division jitter in the magnetic arrangement of transducer wheel and sensor element favorably amounts to at most 2%. A combination of the air gap increase and period jitter reduction is of course also possible.

The present invention also relates to a wheel bearing sensor unit according to claim 22.

In the wheel bearing sensor unit of the present invention the encoder, which is usually integrated in the wheel bearing seal, has a relatively small reading track diameter. Compared thereto, the necessary air gap tolerances are, however, essentially as large as with wheel speed sensor arrangements not integrated in the wheel bearing.

If the reading track diameter was decreased for the purpose of the desired resolution increase in known wheel bearing sensor arrangements, the module would diminish at a given air gap which is unfavorable in view of the manufacturing costs for the encoder. Also, a finer subdivision of the north/south-pole pairs would also be disadvantageous with a given reading track diameter because the module would diminish to half, e.g. when the angular resolution is doubled. Consequently, the problem of the low ratio of module to air slot cannot be improved in the two above-mentioned cases. The same unfavorable correlation occurs with respect to the pole division jitter.

On account of the internal resolution increase of the sensor, the arrangement of the present invention achieves the advantage that the utilizable air gap range increases until the allowable limit value of the period jitter is reached.

Further embodiments of the present invention are implemented in the motor vehicle influencing device as claimed in claim 23 and in the method for intervention in the further ride of a motor vehicle according to claim 26.

The motor vehicle influencing device of the present invention generally comprises the components of a per se known vehicle dynamics control, the said control being extended by appropriate circuits or other appropriate means for evaluating the direction signal according to the invention. Beside a variation of the input circuit, such means, among others, may consist in an extension of the algorithms of a control loop by way of appropriate additional subprograms, said control loop being processed by a microprocessor.

For influencing the further ride the device includes a means for influencing the further ride such as algorithms in a brake control unit that intervene into the brake algorithms, or an interface for intervention into the engine management, or an interface to an electronically controllable clutch. Rolling of the vehicle on an inclined surface may be prevented in a particularly favorable manner by way of the influencing means in connection with the above-described direction-sensitive high-resolution rotational speed sensor, with the system described being especially suited as a hill holder when driving uphill.

As has been described hereinabove, the wheel speed sensor of the present invention is preferably integrated into a wheel bearing. In an especially favorable manner, said sensor is used in wheel bearing arrangements wherein the wheel bearing seal is additionally used as a magnetized encoder.

It is also favorable to employ the sensor of the invention in electric steering systems.

Further, the present invention relates to the use of the sensor of the invention in systems with already provided immobilizing systems or in anti-theft systems for vehicles and in brake pedal travel generators for motor vehicles.

The brake pedal travel generator mentioned above to which the invention also relates, favorably concerns a device wherein a linear or rod-shaped encoder is moved along with a force take-over means (for example, a rod for transmitting the force of a brake pedal onto the brake cylinder) which moves as a result of the brake application, and with the device comprising two or more active wheel speed sensor elements of the invention that are stationarily coupled to the housing of the device. A corresponding brake device is described in the older German patent application DE 100 10 042 A1. The device described especially comprises a displaceable element with the encoder, said element being guided by a bearing connected to the stator. The bearing encompasses the displaceable element at least in part and leads it in an axial direction. The encoder is positively connected to, in particular embedded in, the displaceable element.

Favorably, the brake pedal travel generator of the invention, beside a particularly small hysteresis, includes direction detection and high resolution of displacement.

Further favorable embodiments of the present invention can be seen in the sub claims or the following description of the Figures.

In the drawings,

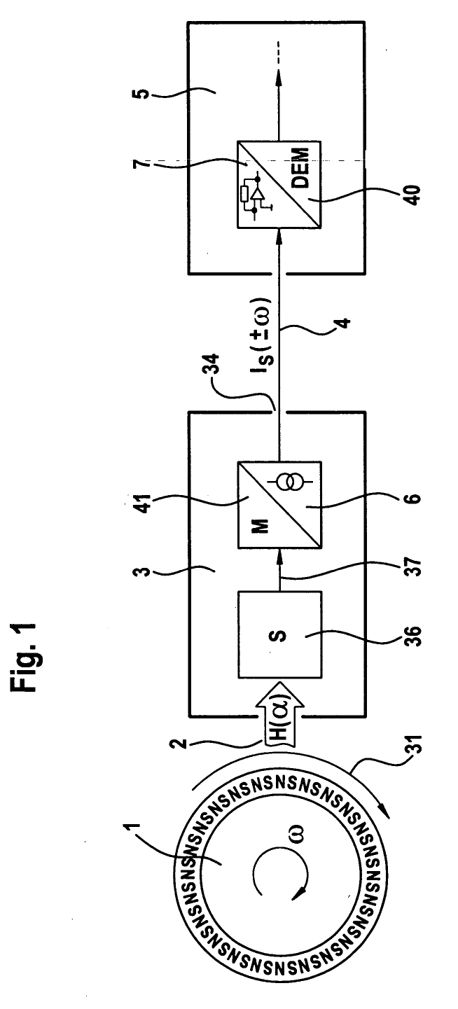

FIG. 1 is a schematic view of an arrangement for detecting wheel speeds according to the state of the art.

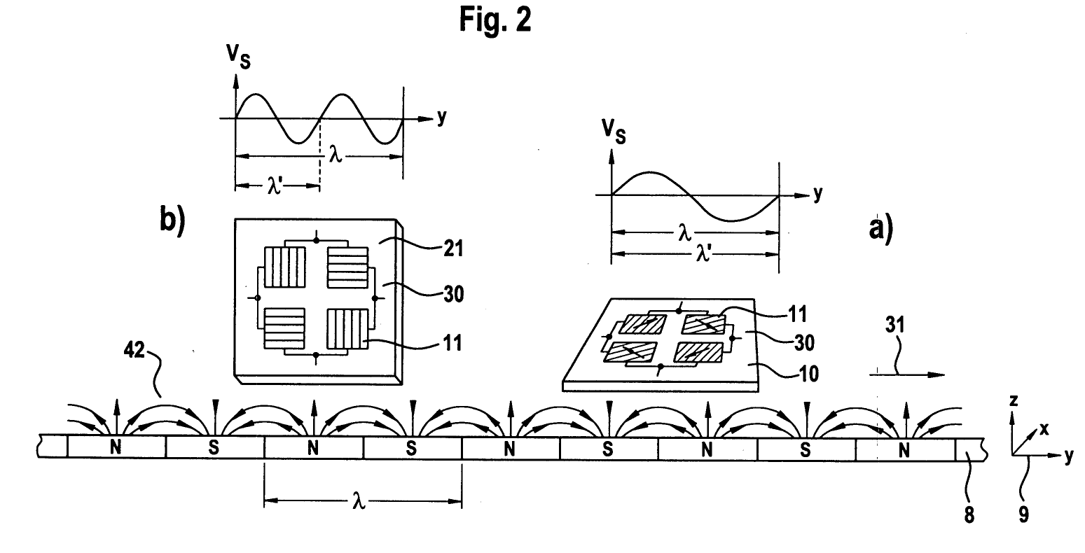

FIG. 2a is a view of an arrangement with magnetic sensor element without Barper poles with a rotating field vector.

FIG. 2b is an arrangement of the present invention of a sensor element with Barper poles.

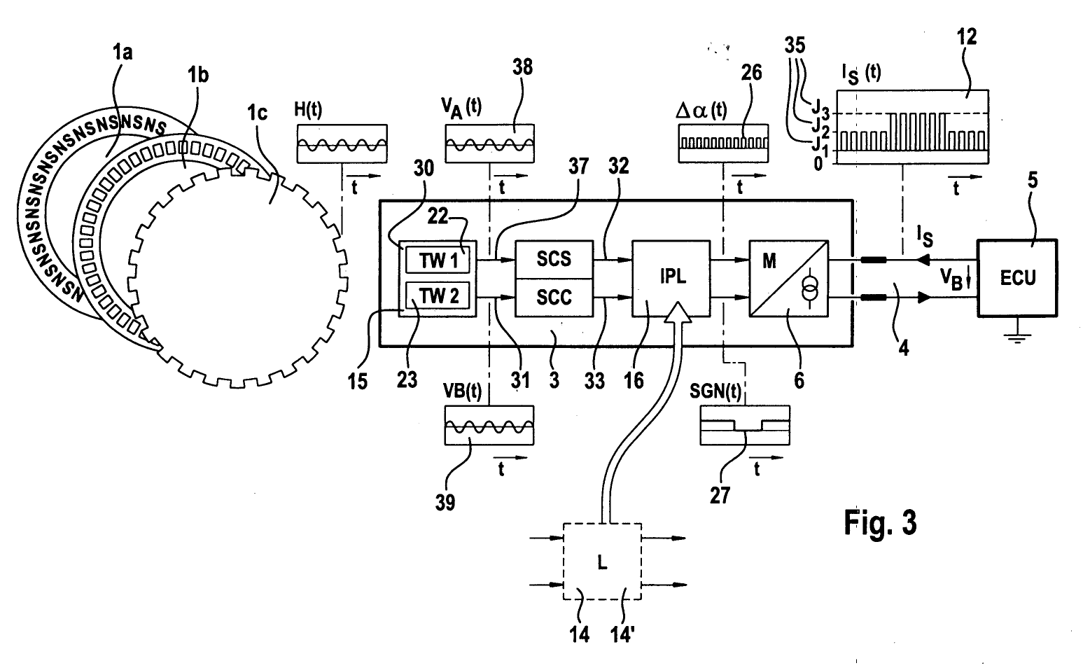

FIG. 3 shows an arrangement of the invention with encoder and active sensor with two partial transducers.

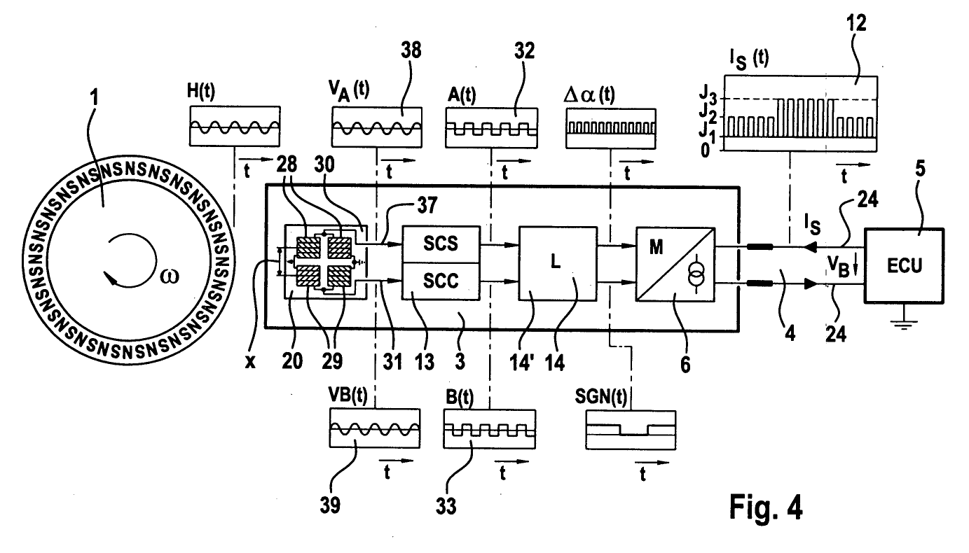

FIG. 4 shows another arrangement of the invention with encoder and active sensor comprising an alternative AMR sensor element with half bridges shifted by the amount ‘x’ in relation to each other.

FIG. 1 shows the general structure of a generic sensor assembly with an active travel sensor or angular sensor 3. It comprises a rotating encoder 1 with north/south pole magnetization that rotates in the direction of the arrow 31. The angle-responsive magnetic signal 2 (magnetic field H(α), see also reference numeral 42 in FIG. 2) is produced during the rotation. The magnetic signal 2 is received by the sensor element of an active sensor 3, being stationarily connected to the body of the motor vehicle, and converted into an electric signal.

The sensor element 36 is configured in such a fashion that, apart from the angular velocity of the encoder, the direction of rotation or, respectively, the direction of displacement of the encoder may be derived from the electric output signals in addition. The rotational speed information and the direction-of-rotation information are sent to a modulator 41 producing a coded signal therefrom. The modulator then actuates one or more current sources 6 to produce the signal current.

In accordance with the sensor element signals, the current source 6 generates a signal current Is at interface 4 with square-shaped current pulses, which current is sent to an electronic controlling device 5 by way of a two-wire line, it being possible for the brake control unit to be in general a controlling device equipped with a microprocessor system.

It can be expedient in defined cases to transmit additional information in the form of coded pulses in a per se known manner between the wheel speed pulses in the pulse pauses of the rotational speed signals. The additional signals can be transmitted in the form of individual bits, with each individual bit indicating e.g. an operating condition of the wheel (air gap, direction of rotation, etc.) or also of the brake (e.g. brake lining wear). Appropriately, the amplitude of the additional signals is smaller than the amplitude of the rotational speed pulses.

Control unit 5 comprises an input stage 7 to evaluate the interface signals, and a demodulation stage 40 is connected downstream of input stage 7 wherein the angular velocity and the direction of rotation are recuperated as separate pieces of information.

FIG. 2 shows schematically the developed view 8 of an encoder track. Along the encoder track extend the magnetic field lines H(α) 42 or, in the layout case, H(y) generally in y and z direction of the space in accordance with the system of coordinates 9 with the vector components x, y and z.

FIG. 2a shows an arrangement wherein the signal period λ′ basically corresponds to the encoder period λ′. The AMR structure 10 is composed of an area with a bridge circuit made of four individual elements 11. The area of the sensor element is aligned in parallel to the encoder track, that means, the area normal points in the direction of the z-axis (normal on the encoder track). When the sensor element moves along the y-axis, the magnetic field vector rotates in the z-direction through the area plane of the AMR structure. With sensor elements 10 and 21 in the partial picture a), so-called Barber poles are superposed as structures on the AMR elements in a per se known manner, as is conventional practice in the field of wheel speed sensor equipment, with the result that among others the period of the sensor signal can be adapted to the period.

The sensor element in FIG. 2b, which may also be employed in the active sensor of the invention, does not dispose of any Barber poles. The area 30 is aligned vertically to the encoder track in contrast to FIG. 2a. The sensor elements comprise a bridge circuit made of AMR elements 11. When the sensor element moves along the y-axis, the magnetic field vector rotates in the z-direction through the area plane of the AMR structure. At the electrical output of the sensor element, the signal Vs having a signal period λ′ which is half as great as the encoder period λ develops per north/south period λ. This achieves an increase in resolution compared to the arrangement in FIG. 2a.

When employing a sensor element of FIG. 2b for wheel bearing sensors, it is appropriate to select 24 pole pairs per circumference with a conventional reading diameter so that, on account of the increase in resolution described hereinabove, again the nominal resolution of 48 signal periods per wheel rotation is achieved, which is desired for ABS control apparatus.

FIG. 3 shows an active sensor 3 of the invention which is herein used to sense the magnetic field changed by a generator wheel. Besides permanent-magnetic generator elements 1a (encoder), also ferromagnetic structured generator elements such as toothed discs 1b or gear wheels 1c may be used as generator wheel 1, and additional permanent magnets are needed, which are favorably attached to the rotational speed sensor, in the case of non-permanent-magnetic generator wheels.

The sensor element 15 comprises two partial transducers TW1 and TW2 that are displaced or twisted in relation to one another. The partial transducers TW1 and TW2 may be magneto-resistive elements or Hall elements.

The shift or twist causes the development of two independent phase-shifted electric partial signals 38 and 39, especially with a signal course according to the relation

A(t)=A·Sin(ω·t) and

B(t)=B·Sin(ω·t±φ),

and said signals are sent to the channels SCS and SCC of the signal conditioning stage 13. The pulse signal conditioned by the signal conditioning stage 13 is either delivered to an interpolator stage 16 or to a logical unit 14.

The interpolator circuit 16 is a signal sequential circuit performing sampling of the input signal.

Interpolator stage 16 electronically subdivides each period ωt of the signals 32 and/or 33 of 360° in smaller angular segments (e.g. 45°) and then processes the signals in such a fashion as to make available a pulse-shaped speed signal 26 and a pulse-shaped direction signal 27 at the output of the interpolator 16. Rotational signal 26 herein has the shape of a pulse chain representing fractions of angular segments (e.g. 45°) of the encoder periods (ωt=360°). The frequency of the pulse chain images the rotational velocity with an increased angular resolution.

To adjust the desired displacement resolution, the interpolation factor (degree of fine graduation) may be varied in a per se known fashion by a suitable circuit design.

It may be appropriate for the design of the circuit to have change-over elements in the circuit that allow the control unit 5 to switch over the interpolation factor of the interpolator circuit 16 also by way of interface 4.

With the alternatively employable logical unit 14, the input signals are processed and the signals 25 (Δα(t)) and 27 (SGN(t)) are provided at the interface between 14 and 6. Signal 25 is a pulse chain whose pulses develop synchronously to the angular positions of the north/south poles with respect to the position of the sensor element so that the frequency of the signal 25 images the rotational velocity of the encoder.

After a first example for realizing the logical unit 14, all positive and negative edges of both signals 32 and 33 are evaluated to generate the pulse chain 25. This causes an increased displacement resolution of one eighth of the angular segment of one individual north/south pole pair of the encoder. This case of application is favorable when the objective is to achieve a particularly high displacement resolution of the wheel speed sensor of the invention.

In another example for realizing the functional unit 14 all positive and negative edges of only one of the signals 32 or 33 is evaluated to generate the pulse chain 25. The displacement resolution then amounts to one fourth of the angular segment of an individual north/south pole pair of the encoder. It is just as well possible to evaluate either the positive or the negative edges of both signals.

The displacement resolution in both cases is only half as high as this would be the case with full utilization of the signals.

By way of an electric current interface 4, the active sensor is connected to an electronic control unit of a brake unit 5 which provides for an energy supply (operating voltage VB) for the sensor by way of a basic current of constant flow. Pulse-shaped wheel speed signals 12 are transmitted with the signal current Is(t) by way of the two-wire line 24, with the distance of the pulses being an indicator of the circumferential speed of the encoder. The signal current additionally transmits the direction-of-rotation information by way of the pulse height to the control unit 5 in which the signal may be decoded in a simple fashion by means of an appropriate decoding stage.

In the electronic control unit 5, the signals transmitted after the decoding operation by way of the interface 4 are suitably used to actuate electronic counters that temporally measure the subsequent edge distances and, thus, provide a standard for the wheel speed.

The signal current 12 comprises a chain of short current pulses of a duration of preferably at most 100 μs. Two different pulse heights with the current levels J1, J2, and J3 are arranged for to transmit the direction-of-rotation information.

In a particularly favorable manner the rates of current strength are selected as follows:

J1=3 mA, J2=7 mA, and J3=14 mA, it being necessary to still identify values in the range of +−20% in the decoding stage as an allowable tolerance band. Of course, it is also possible to choose other suitable combinations of current levels.

The coding involves that the leading edge of each pulse, irrespective of the pulse height, is evaluated as wheel speed pulse and, hence, is an indicator of the wheel speed. The advantage achieved hereby is that the wheel speed pulse and the associated direction-of-rotation information can be transmitted synchronously. This prevents a time delay of both types of signals distinguishing by their pulse height, which is especially advantageous to determine the rolling distance of a wheel beginning with a predetermined starting point.

According to another, non-illustrated example of the present invention, the functional group 10 is an arrangement of two differential Hall elements having areas that act like sensors which are in close adjacency in relation to the north/south pole period λ of the magnetized encoder, namely in such a fashion that in turn two phase-shifted, in the ideal case orthogonal signal voltages (VA(t) and VB(t) are produced when the encoder rotates. The Hall areas are aligned preferably vertically to the encoder in this case so that the vector of the field component exiting perpendicular from the magnet poles extends vertically through the area plane of the Hall structure.

The above-described arrangement permits processing the signals in functional unit 14 in such a fashion that a displacement resolution of one fourth of the angular segment or, alternatively, a displacement resolution of one half of the angular segment can be reached.

FIG. 4 shows another example for an active motor vehicle speed sensor 3. Sensor 3 differs from the sensor in FIG. 3 by a modified sensor element 20. Sensor element 20 comprises two AMR half bridges or half bridge branches which are shifted by the mid distance X in relation to one another and, as described hereinabove, lead phase-shifted, especially generally orthogonal, electric signals 38 and 39 to the conditioning stage 13.

In connection with sensor element 20, it is especially suitable to employ a magnetized encoder, however, the above-described encoders, which are not self-magnetized and have a biasing magnet, can also be used.

1. Active magnetic field sensor, in particular for detecting the wheel rotational speed in motor vehicles, comprising at least one magnetic sensor element (10, 21, 36) for converting a temporally periodic magnetic field into a temporally periodic electric sensor signal at signal outputs (37, 31) and an electronic signal evaluating circuit, the said magnetic field sensor being electrically fed by way of a sensor interface,
characterized in that an active electric processing of periodic signals (38, 39) of the magnetic sensor element is performed in two or more separate signal channels of the evaluating circuit respectively associated with the sensor signals.

2. Magnetic field sensor as claimed in claim 1,
characterized in that in an electric circuit element (16) of the signal evaluating circuit one or more signal periods which originate from the sensor element are subdivided into small angular segments so that one or more signals with an increased angular resolution develop.

3. Magnetic field sensor as claimed in claim 1 or 2,
characterized in that the information obtained from the signal channels such as rotational speed signals, directional signals, etc., is output time-synchronously at the signal outputs.

4. Magnetic field sensor as claimed in at least any one of claims 1 to 3,
characterized in that at a first and at another signal output (37, 31) of the magnetic sensor element, one first and another electric periodic sensor signal (38, 39) is respectively produced, wherein in particular the second sensor signal of the sensor element includes a phase shift of ±φ with respect to the first sensor signal.

5. Magnetic field sensor as claimed in at least-any-one of claims 1 to 4,
characterized in that two or more independent partial transducers (22, 23, 28, 29) are arranged on a planar main plane (30) of the sensor element and, for generating a phase shift ±φ, are spatially shifted by a defined amount or twisted by a defined angle in relation to each other.

6. Magnetic field sensor as claimed in at least any one of claims 1 to 4,
characterized in that the partial transducers are bridge circuits and/or partial branches of bridge circuits.

7. Magnetic field sensor as claimed in at least any one of claims 1 to 5,
characterized in that the partial transducers comprise magneto-resistive elements or Hall elements.

8. Magnetic field sensor as claimed in at least any one of claims 1 to 6,
characterized in that the partial transducers comprise differential Hall elements.

9. Magnetic field sensor as claimed n at least any one of claims 5 to 8,
characterized in that the main plane (30) is aligned in parallel to an area produced by the normal on the encoder track (42) and the direction of rotation of the encoder (46).

10. Magnetic field sensor as claimed in at least any one of claims 5 to 9,
characterized in that the bridge circuits are Wheatstone bridges which are twisted relative to each other by an angle of about 45°.

11. Magnetic field sensor as claimed in at least any one of claims 1 to 10,
characterized in that an output signal (12) is produced at an outwardly extending signal output of the sensor (34), the said output signal containing the rotational speed information of an encoder passed by the sensor in a pulse-coded manner, with the amplitude of the rotational speed signal being taken into account for coding the direction of rotation.

12. Magnetic field sensor as claimed in at least any one of claims 1 to 11,
characterized in that in a signal-conditioning stage (13) the sensor signals (38, 39) are converted electronically into amplified square-wave signals (32, 33) which have the same frequency as the sensor signals and wherein the original phase shift between the signal channels is maintained.

13. Magnetic field sensor as claimed in claim 12,
characterized in that all positive and/or negative edges of the square-wave signals (32) of a first channel and/or all positive and negative edges of one or more further square-wave signals (33) are evaluated in an electric circuit element (14).

14. Magnetic field sensor as claimed in claim 13,
characterized in that all positive and negative edges of the square-wave signal (32, 33) are evaluated in an electric circuit element (14′) by only one channel or by two channels.

15. Magnetic field sensor as claimed in claim 13 or 14,
characterized in that the edge information of the incoming signal(s) is/are processed in the circuit element (14, 14′) in such a fashion as to produce a first signal with an information about the rate of motion (25) and a second signal with an information about the direction of rotation (27).

16. Magnetic field sensor as claimed in claim 15,
characterized in that the rate-of-motion signal (25) and the direction-of-rotation signal (27) are sent to a modulator (6) which produces from both signals one single amplitude-modulated pulse signal exiting from the output of the active sensor.

17. Magnetic field sensor as claimed in at least any one of claims 1 to 16,
characterized in that current pulses are output at the output of the sensor (34) by way of a two-wire interface (4), said current pulses having a distance that is an indicator of the circumferential speed of an encoder that passes by the sensor element, with said current pulses apart from a possibly predefined offset current having two fixedly predefined different, non-overlapping zones (35) of nominal values of the current level which are different from zero.

18. Magnetic field sensor as claimed in claim 17,
characterized in that the pulse duration of the output rotational speed pulses is constant.

19. Magnetic field sensor as claimed in at least any one of claims 1 to 18,
characterized in that the signal conditioning stage (13), the circuit element (14, 14′, 16), and the modulator (6) are integrated in a joint housing, in particular on a joint chip.

20. Magnetic field sensor as claimed in at least any one of claims 1 to 19,
characterized in that the displacement resolution with which the active sensor samples the periodic magnetic field can be selected by means of an external control signal that is transmitted by way of a bus or a line.

21. Sensor assembly comprising a magnetic field sensor as claimed in at least any one of claims 1 to 20, and an encoder,
characterized in that the encoder is a permanent-magnetic encoder (1a) or a ferromagnetic encoder (1b, 1c).

22. Wheel bearing sensor unit comprising an annular encoder that is integrated in particular in a wheel bearing seal, and an active sensor,
characterized by an active magnetic field sensor as claimed in at least any one of claims 1 to 20.

23. Motor vehicle influencing device comprising several encoders connected to the wheels and each having at least one magnetic field sensor sampling the encoder as claimed in at least any one of claims 1 to 20, and an electronic control unit (5) connected to the active sensors by way of interfaces (4),
characterized in that the device, in particular the control unit, comprises means influencing the further ride for processing the wheel rotational speed information and the direction-of-rotation information, thereby preventing undesirable rolling of the vehicle on an inclined plane in dependence on the wheel rotational speed information.

24. Use of the magnetic field sensor as claimed in at least any one of claims 1 to 20 in immobilizing systems and/or drive-away interlock systems and/or anti-theft systems.

25. Use of the magnetic field sensor as claimed in at least any one of claims 1 to 20 in brake pedal travel generators for motor vehicles wherein a linear rod-shaped encoder is displaced in dependence on brake pedal application, in particular in electrohydraulic or electromechanical brake and driving dynamics control systems.

26. Method for engagement into the further ride of a motor vehicle,
characterized in that by means of intervention into a vehicle steering device, in particular a control unit of a driving dynamics and/or brake controller, rolling of the motor vehicle on an inclined plane is prevented by evaluation of motional signals and direction signals of a magnetic field sensor as claimed in at least any one of claims 1 to 20 by means of the vehicle control unit.
